(19) United States
(12) Patent Application Publication
(10) Pub. No.: US 2014/0255682 A1
(43) Pub. Date: Sep. 11, 2014

(54) NANOENGINEERED SUPERHYDROPHOBIC ANTI-CORROSIVE ALUMINUM SURFACES

(71) Applicant: THE TRUSTEES OF THE STEVENS INSTITUTE OF TECHNOLOGY, Hoboken, NJ (US)

(72) Inventors: Chanyoung Jeong, Allison Park, PA (US); Chang-Hwan Choi, Demarest, NJ (US)

(21) Appl. No.: 14/199,489

(22) Filed: Mar. 6, 2014

Related U.S. Application Data
(60) Provisional application No. 61/775,002, filed on Mar. 8, 2013.

(51) Int. Cl. B32B 3/26

(52) U.S. Cl. CPC B32B 3/26
USPC 428/319.1

(57) ABSTRACT

An aluminum substrate is provided with a superhydrophobic surface structure that comprises a porous alumina layer having a hydrophobic coating. The porous alumina layer is created on the aluminum substrate by an anodizing process, and is engineered such that the thickness of the alumina layer and the diameters of the pores have nanoscale values. The anodizing process is performed in two anodizing steps with an intermediate etching step. The superhydrophobic surface provides protection against corrosion by entrapping air in the pores so as to prevent penetration of water to the aluminum metal.

### CROSS-REFERENCE TO RELATED APPLICATIONS

The present application claims the benefit of U.S. Provisional Patent Application No. 61/775,002, filed on Mar. 8, 2013, which is incorporated by reference herein in its entirety.

### STATEMENT REGARDING FEDERALLY-SPONSORED RESEARCH

Certain technology disclosed herein was derived from research supported by the U.S. Government under the Office of Naval Research Award Number N00014-10-1-0751. The U.S. Government may have certain interests in that technology.

### FIELD OF THE INVENTION

The present invention relates to the surface treatment of metals to inhibit corrosion, and, more specifically, to nanoengineered superhydrophobic metal oxide surfaces on metal.

### BACKGROUND OF THE INVENTION

Metal corrosion is a serious problem with consequences that are manifest in economics, environmental quality, and human well-being, and in many engineered systems such as aircraft, automobiles, pipelines, and naval vessels. Aluminum is an important structural metal in such engineered systems. The major incentive for employing light metals such as aluminum in engineered systems is its light weight compared to steel. The initial cost premiums resulting from the use of aluminum are justified over the life of the system by the benefits provided by the light weight and low maintenance costs of the aluminum structures. However, because of its relatively low resistance to corrosion in salt water, aluminum surfaces must be protected by measures such as thick coatings, painting, or cathodic protection in order to provide a satisfactory service life. Unfortunately, the implementation of many anti-corrosion methods may be adversely impacted by environmental regulations, losses in hydrodynamic efficiency, and lack of durability of the surface treatment.

A recent approach to preventing corrosion of metal surfaces is the provision of superhydrophobic surfaces on the metal surface. If a hydrophobic surface with low surface energy is roughened or textured properly, a superhydrophobic surface may be formed that creates a composite interface with a liquid by retaining air between structural features of the superhydrophobic surface. The retention of air by such superhydrophobic surfaces can create an effective passivation layer against corrosion by minimizing the direct contact of liquid with the corrosive metal surface.

Prior development and experimentation with superhydrophobic surfaces for light metals are based on irregular surface roughening and/or the use of chemical coatings, which resulted in random surface roughness on the micrometer scale. Such random microscale surface roughness, with the attendant poor controllability of the structural dimensions and shapes of the roughened surface, has been a critical drawback of such approaches, precluding a systematic understanding of the effect of superhydrophobic surface parameters on corrosion resistance, and, hence, on the optimization of surface conditions to inhibit corrosion.

### SUMMARY OF THE INVENTION

In an embodiment of the present invention, a metal substrate has a superhydrophobic surface structure. In embodiments of the present invention, the superhydrophobic surface structure includes a nanoporous layer of an oxide of the metal, the nanopores extending through the thickness of the metal oxide layer. In some embodiments of the present invention, the metal oxide layer is coated with a hydrophobic polymer, such as Teflon®. In some embodiments, the inner walls of the nanopores have a coating of hydrophobic coating. The nanoscale structure of the superhydrophobic surface structure allows air to be trapped in the nanopores under water pressure so as to exclude the water from entering the nanopores, thereby minimizing contact between the metal substrate and the water. In some embodiments of the present invention, the metal is aluminum and the metal oxide is alumina.

In an embodiment of a method according to the present invention, a superhydrophobic surface structure is formed on a metal substrate by an anodizing process. In some embodiments of the present invention, the method includes the following steps: (a) providing a metal substrate; (b) anodizing the metal substrate so as to form a first metal oxide layer on the metal substrate, the first metal oxide layer having a plurality of first nanoscale pores extending therethrough; (c) removing the first metal oxide layer from the metal substrate by an etching process, thereby providing the metal substrate with a pattern of exposed metal thereon; (d) anodizing the metal substrate so as to form a second metal oxide layer on the pattern of exposed aluminum, the second alumina layer having a plurality of second nanoscale pores extending therethrough; and (e) providing a hydrophobic polymer coating on the second metal oxide layer. In an optional step, the diameters of the second nanoscale pores are increased by an etching process before the hydrophobic polymer coating is provided. In some embodiments of the present invention, the metal is aluminum, and the metal oxide is alumina.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic conceptual illustration of a superhydrophobic surface according to an embodiment of the present invention;

FIG. 2 is a schematic conceptual illustration of an anodizing apparatus useful for preparing nanoporous alumina layers on an aluminum substrate according to an embodiment of the present invention;

FIG. 3 is a schematic conceptual illustration of selected steps in the preparation of nanoporous alumina structures on an aluminum substrate according to an embodiment of the present invention;

FIG. 4 is a scanning electron microscope (SEM) image of an aluminum surface before being anodized by a method according to an embodiment of the present invention;

FIG. 5 is a SEM image of a first nanoporous alumina layer according to an embodiment of the present invention;

FIG. 6 is a SEM image of a second nanoporous alumina layer according to an embodiment of the present invention;

FIG. 7 is a SEM image of a third nanoporous alumina layer according to an embodiment of the present invention;

FIG. 8 is a SEM image of a fourth nanoporous alumina layer according to an embodiment of the present invention;

FIG. 9 is a plot of contact angles of water droplets on exemplary superhydrophobic surfaces prepared according to embodiments of the present invention, with schematic drawings illustrating same;

FIG. 10 is a schematic diagram of a corrosion measurement system used to assess the anti-corrosive properties of exemplary superhydrophobic surfaces prepared according to embodiments of the present invention;

FIG. 11 is a schematic diagram of a three-electrode system that is a component of the corrosion measurement system of FIG. 10;

FIG. 12 is a plot of potentiodynamic polarization values for pure aluminum and for a nanoporous alumina surface prepared according to an embodiment of the present invention;

FIG. 13 is a plot of potentiodynamic polarization values for an exemplary nanoporous alumina surface prepared according to an embodiment of the present invention and an exemplary Teflon® coated nanoporous alumina surface prepared according to an embodiment of the present invention;

FIG. 14 is a plot of potentiodynamic polarization values for four exemplary Teflon® coated nanoporous alumina surfaces prepared according to an embodiment of the present invention; and

FIG. 15 is a plot of corrosion inhibition efficiencies for pure aluminum, an exemplary nanoporous alumina surface prepared according to an embodiment of the present invention, and four exemplary Teflon® coated nanoporous alumina surfaces prepared according to an embodiment of the present invention.

### DETAILED DESCRIPTION OF THE EXEMPLARY EMBODIMENT

The present invention relates to the development of highly-efficient superhydrophobic aluminum surfaces with superior anti-corrosion properties by means of electrochemical anodizing processes. Anodizing processes are highly-scalable and effective manufacturing techniques for designing and manufacturing well-defined and well-controlled nanoscale pore structures (also referred to herein as “nanopores”) from light metals such as aluminum. In embodiments of the present invention, such nanoscale pore structures promote the superhydrophobic properties at the nanoengineered surfaces of light metals for anti-corrosion applications. For the purpose of the present disclosure, a “surface” is a physical structure exposed at the exterior of an object and integral thereto.

In an embodiment of the present invention, a self-ordered hexagonal array of nanoporous structures of aluminum oxide (e.g., an alumina layer) is grown on top of an aluminum substrate using electrochemical anodizing techniques. The resulting surface may also be referred to as a “nanotextured surface”. During the anodizing process, the shape and dimensions of the nanopore pattern can be conveniently controlled by controlling the conditions of the anodizing process, such as voltage, temperature, acidity of the anodizing bath, and duration. In embodiments of the present invention, the nanotextured surface is coated with a hydrophobic polymer. In embodiments of the present invention, the nanotextured surface is coated with Teflon® fluoropolymer by spin coating. In embodiments of the present invention, the thickness of the Teflon® coating is regulated by controlling the spin speed and the concentration of fluoropolymer in solution. Coatings that are only a few nanometers thick can thus be obtained. In embodiments of the present invention, the coated nanotextured surface is annealed to promote strong adhesion of the coating onto the nanotextured surface. In such embodiments, the nanotextured surface becomes superhydrophobic, showing high water repellency and low adhesion. When such a surface is contacted by water, gas (e.g., air) is entrapped in the nanopores, and the entrapped gas (also referred to herein as a “retained gas”) acts as a passivation/protection layer against corrosion by reducing the direct contact between water and substrate surface.

The anodizing processes used in the present invention can be used to closely control the pore diameters and the thickness of the oxide layer across a range of sizes. Such control allows the properties of the superhydrophobic surface of the present invention to be optimized to maximize the degree of anti-corrosion protection for various metals and environmental conditions. In general, thicker oxide layers having larger pore sizes allow the retention of greater amounts of gas, and, hence, provide a greater protection against corrosion of the underlying metal. The exemplary embodiments of the present invention that are discussed herein are demonstrated to have controllable superhydrophobic and anti-corrosive properties. The methods of preparing superhydrophobic anti-corrosive surfaces presented herein are also exemplary embodiments of the present invention.

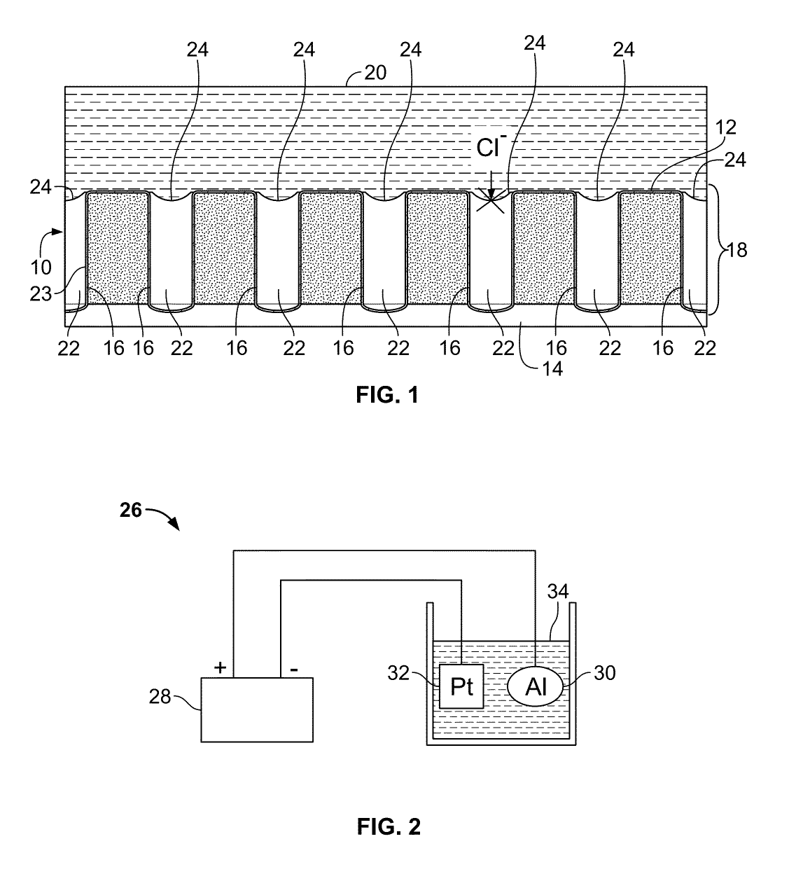

FIG. 1 is a schematic conceptual illustration of nanostructured superhydrophobic surface 10 according to an embodiment of the present invention. The superhydrophobic surface 10 comprises a nanostructured metal oxide layer 12 on a metal substrate 14. The surface has a plurality of nanoscale pores 16 (i.e., “nanopores”) therein. The nanostructured hydrophobic surface 10 creates a composite interface 18 with water (e.g., salt water 20) by retaining gas (e.g., air 22) within the pores 16. The composite interface 18 minimizes the area across which the salt water 20 contacts the aluminum substrate 14, thus preventing corrosion (e.g., by preventing penetration of chloride ions (e.g., chloride ion Cl⁻) to the metal substrate 14). In the exemplary embodiments discussed herein, the metal substrate 14 is an aluminum substrate 14, and the metal oxide layer 12 is an alumina layer 12, and will be referred to as such hereinafter. The scope of the present invention, however, includes any engineered nanoporous structure on the exterior of a metal object that retains a gas in the nanopores when in contact with a liquid, as well as methods of making such structures. For example, most metals, including, but not limited to, titanium, magnesium and steel, may be used in place of aluminum in embodiments of the present invention, with appropriate adjustments to the anodizing and etching conditions discussed herein.

In order to maintain the superhydrophobic properties of the superhydrophic surface 10, water 20 should not accumulate in the pores 16. Thus, the alumina layer 12 should be rendered non-wetting (e.g., hydrophobic). This may be achieved by coating the alumina layer 12 with a hydrophobic substance (e.g., Teflon® fluoropolymer). Such a coating, shown in FIG. 1 as Teflon® coating 23, should be present on the inner walls of the pores, and on the areas of the aluminum layer 12 that would be in contact with the salt water 20. Further, the spacing between the pores 16 should be small enough (e.g., nanometer scale) to sustain the water meniscus 24 over the air 22 under pressure, while the pores 16 should be tall and slender to maximize the air volume within the pores 16.

In embodiments of the present invention, the nanostructured alumina layer 12 is formed from the aluminum substrate 14 by an anodizing process. FIG. 2 is a schematic conceptual illustration of an anodizing apparatus 26 useful for preparing the nanostructured alumina layer 12 on an aluminum substrate 14 by such a process. The anodizing apparatus 26 includes an electrical voltage source 28 having a positive pole (+) and a negative pole (−). An aluminum substrate 30 (e.g., one similar to aluminum substrate 14 of FIG. 1) and a non-reactive electrically-conductive electrode (e.g., platinum electrode 32) are immersed in an electrically-conductive bath 34, with the aluminum substrate 30 electrically connected to the negative pole (−) and the platinum electrode 32 electrically connected to the positive pole (+). An electrical voltage is applied across the aluminum substrate 30 and the electrode 32 for a sufficient time, and under appropriate conditions, to oxidize the aluminum substrate 30 where it is exposed to the electrically-conductive bath 34, thereby forming a nanoporous alumina layer (not shown) thereupon.

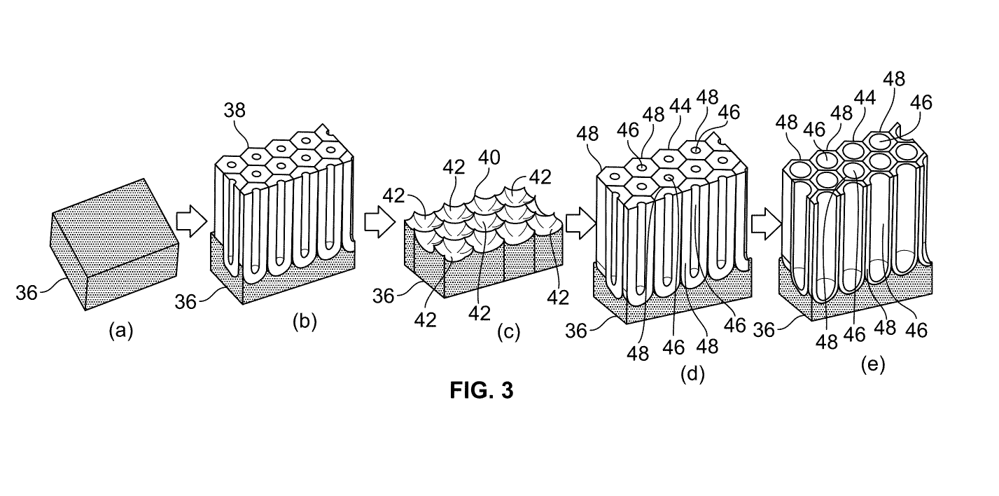

FIG. 3 is a schematic conceptual illustration of steps in a method of preparing nanoporous alumina structures on an aluminum substrate according to an embodiment of the present invention. In general, the following steps are performed: (a) an aluminum substrate 36 is provided; (b) a first nanostructured alumina layer 38 is formed on the aluminum substrate 36 by an anodizing process; (c) the first alumina layer 38 is etched so as to remove it from the aluminum substrate 36, leaving a patterned area 40 of exposed aluminum 42 on the aluminum substrate 36; (d) a second alumina layer 44 having nanopores 46 is formed on the exposed aluminum 42 by an anodizing process; and (e) optionally, the nanopores 46 are etched to increase their size. The formation of the patterned area 40 in step (c) allows the formation of a more uniform array of hexagonal nanostructures 48 having nanopores 46 therein than would be formed by only one anodizing step (e.g., step (b)).

In an exemplary embodiment of the method of FIG. 3, specimens of high-purity (99.9995%) aluminum foil (Goodfellow Corporation, Coraopolis, Pa.), having dimensions of 100 mm×300 mm×0.5 mm), were prepared by degreasing the foil in acetone and ethanol by ultrasonication for 10 min, and rinsing the degreased foil in deionized water for use as an aluminum substrate. Subsequently, each degreased specimen was electropolished in a mixture of perchloric acid and ethanol (HClO₄/C₂H₅OH at a 1:4 volumetric ratio) under an applied potential of 20 V for 3 min at 15° C. to remove surface irregularities. The polished specimens were used as a working electrode (anode) in electrochemical anodization processes, and a platinum electrode was employed as a non-reactive counter-electrode (cathode). The two electrodes were separated by a distance of 5 cm in an electrolyte solution. During the anodization processes, the solution was agitated by a magnetic stirrer to help maintain a uniform anodization process across the surface of the specimen. To obtain a highly-ordered porous alumina layer on the aluminum specimen, the two-step anodizing process discussed with respect to FIG. 3 was used. The first anodizing step was performed in 0.3 M oxalic acid for 10 hours at 40 V and 20° C. After the first anodizing step, the porous alumina layer grown on the aluminum substrate was removed by submerging the specimen in an aqueous mixture solution of 1.8 wt % chromic acid and 6 wt % phosphoric acid at 65° C. for approximately 10 hours. A pattern of exposed aluminum remained on the aluminum substrate, which allowed the formation of a more uniform hexagonal array of porous alumina nanostructures in the second anodizing step. The second anodizing step was performed under the same anodizing conditions described with respect to the first anodizing step. It will be understood by those having ordinary skill in the art that the diameters of the pores may be increased by chemical etching. In the exemplary embodiments discussed herein, the diameters of the pores in the alumina layers were increased by etching the alumina-coated specimen in 0.1M phosphoric acid for 10 minutes at 30° C. As will be understood by the conceptual model of the present invention discussed with respect to FIG. 1, increasing the pore size (i.e., the diameter) allows a greater amount of air to be retained in the pores, which results in a greater degree of superhydrophobicity.

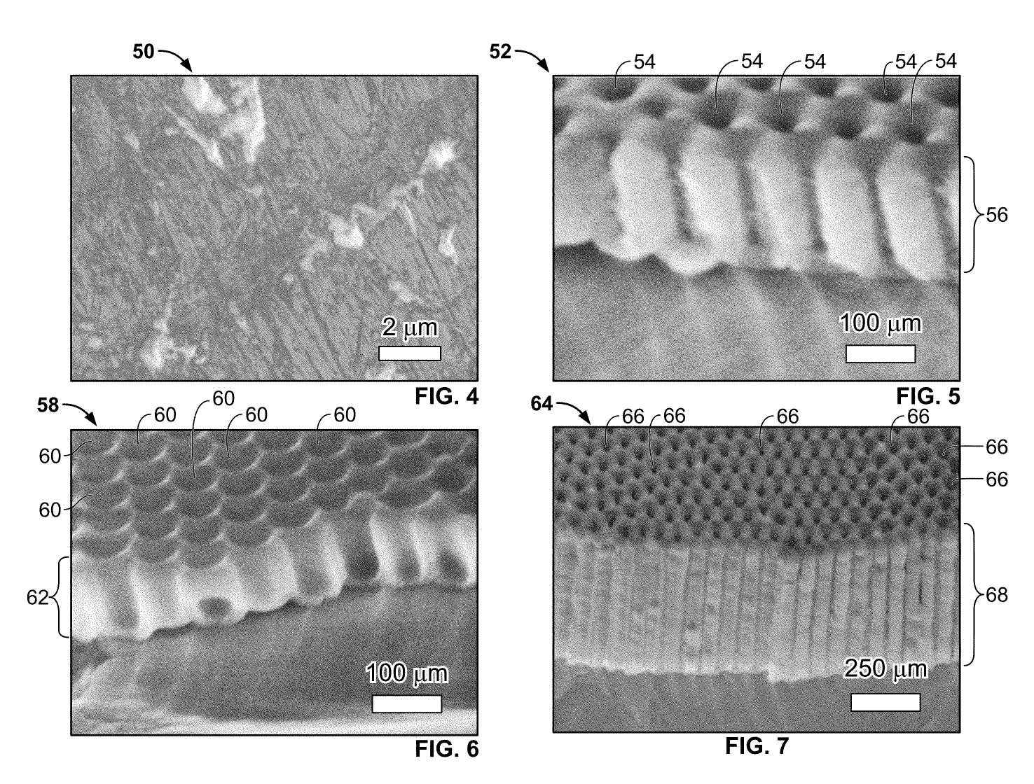

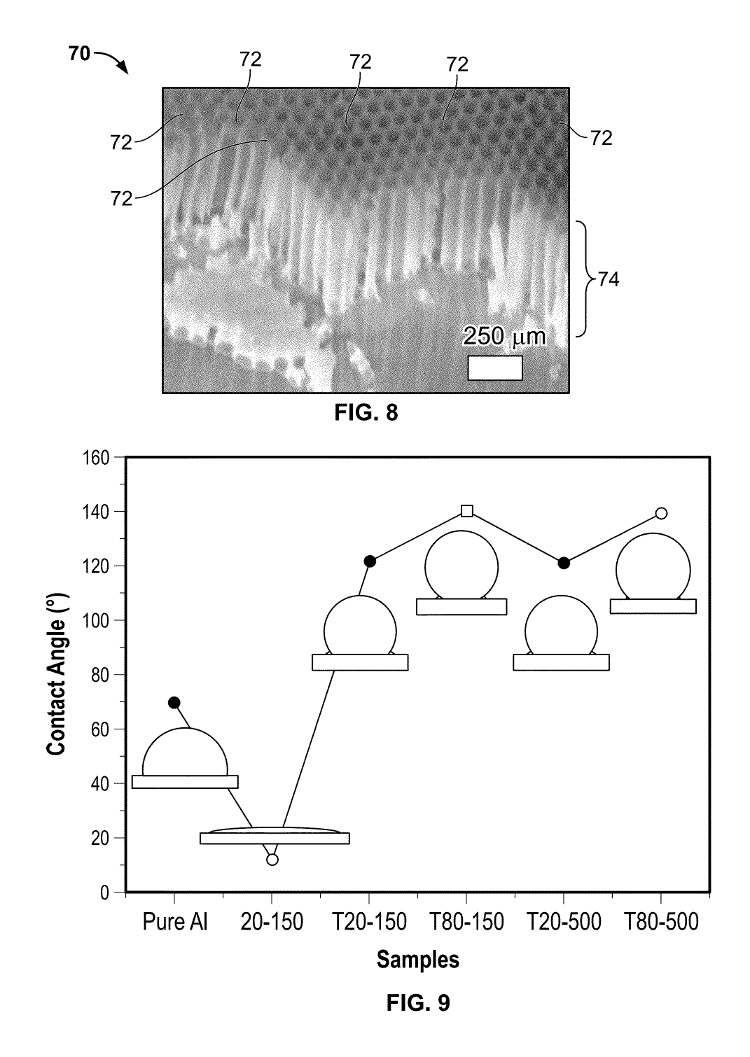

FIGS. 4-8 are scanning electron microscope (SEM) images relating to superhydrophobic surfaces prepared according to methods of the present invention for wettability and corrosion tests. FIG. 4 is a SEM image of a bare high-purity (99.9995%) aluminum foil 50 with no surface anodization. FIG. 5 is a SEM image of a nanoporous alumina layer 52 after a second anodizing step of 50 seconds duration, which resulted in pores 54 having diameters of about 20 nm in an oxide layer 56 having a thickness of about 150 nm. FIG. 6 is a SEM image of a nanoporous alumina layer 58 after a second anodizing step of 60 seconds duration, and subsequent etching of 10 minutes duration, which resulted in pores 60 having diameters of about 80 nm in an oxide layer 62 having a thickness of about 150 nm. FIG. 7 is a SEM image of a nanoporous alumina layer 64 after a second anodizing step of 150 seconds duration, which resulted in pores 66 having diameters of about 20 nm in an oxide layer 68 having a thickness of about 500 nm. FIG. 8 is a SEM image of a nanoporous alumina layer 70 after a second anodizing step of 160 seconds duration, and subsequent etching of 10 minutes duration, which resulted in pores 72 having diameters of about 80 nm in an oxide layer 74 having a thickness of about 500 nm.

Selected specimens of aluminum with nanoporous alumina surfaces were coated with Teflon® to provide the otherwise hydrophilic alumina with a hydrophobic coating. Before being coated with Teflon®, the specimens were cleaned by O₂ plasma (Harrick plasma) for 15 minutes to remove organic residues. The nanoporous alumina layers were then coated with Teflon® at thickness of less than 10 nm by spin coating (1000 rpm for 30 seconds), then baked at 112° C. for 10 minutes, 165° C. for 5 minutes, and 330° C. for 15 minutes in sequence. The coated specimens were dried in air for 1 day.

The nanostructures of the specimens that were tested are described in Table 1, below. The specimens are named by the pore diameter, followed by the thickness of the oxide layer. Specimen names beginning with “T” indicate that the alumina structures of the specimens were Teflon® coated. All other specimens were not coated. Contact angles were measured at multiple locations on the surface of each specimen, than the averages and standard deviations of the observed contact angles were calculated.

TABLE 1
Summary of the surface structures of the specimens

| Surface | Pore | Oxide layer | | Apparent contact |
|---|---|---|---|---|
| specimen | diameter | thickness | Surface | angle (deg) |
| name | (nm) | (nm) | coating | (AVG ± STD) |
| Pure Al | None | Negligible (only | None | 70 ± 0.5 |
| | | native oxide layer) | | |
| 20-150 | 20 | 150 | None | 12 ± 0.1 |
| T20-150 | 20 | 150 | Teflon | 122 ± 0.5 |
| T80-150 | 80 | 150 | Teflon | 140 ± 2.0 |
| T20-500 | 20 | 500 | Teflon | 121 ± 0.5 |
| T80-500 | 80 | 500 | Teflon | 139 ± 1.5 |

The apparent contact angles of a sessile water droplet (about 3 μL) on the surfaces of the non-coated and coated samples were measured by a goniometer (Model 500, ramé-hart instrument company, Succasunna, N.J.) at ambient room conditions. FIG. 9 is a plot of contact angles, with schematic drawings illustrating same. Specimen names are indicated on the horizontal axis. It can be seen that the contact angle values of Teflon®-coated hydrophobic nanoporous surfaces (Specimens T20-150, T80-150, T20-500, and T80-500, all having contact angles in the range of about 121° to about 140°) are greater than those of pure aluminum surface (Specimen Pure Al) and the hydrophilic nanoporous surface (Specimen 20-150). This corresponds to the greater amount of air that may be trapped by the hydrophobic pores in the Teflon®-coated alumina layers. Contact angles are also more pronounced at larger pore sizes, which also correspond to the amount of air that may be trapped by the hydrophobic pores.

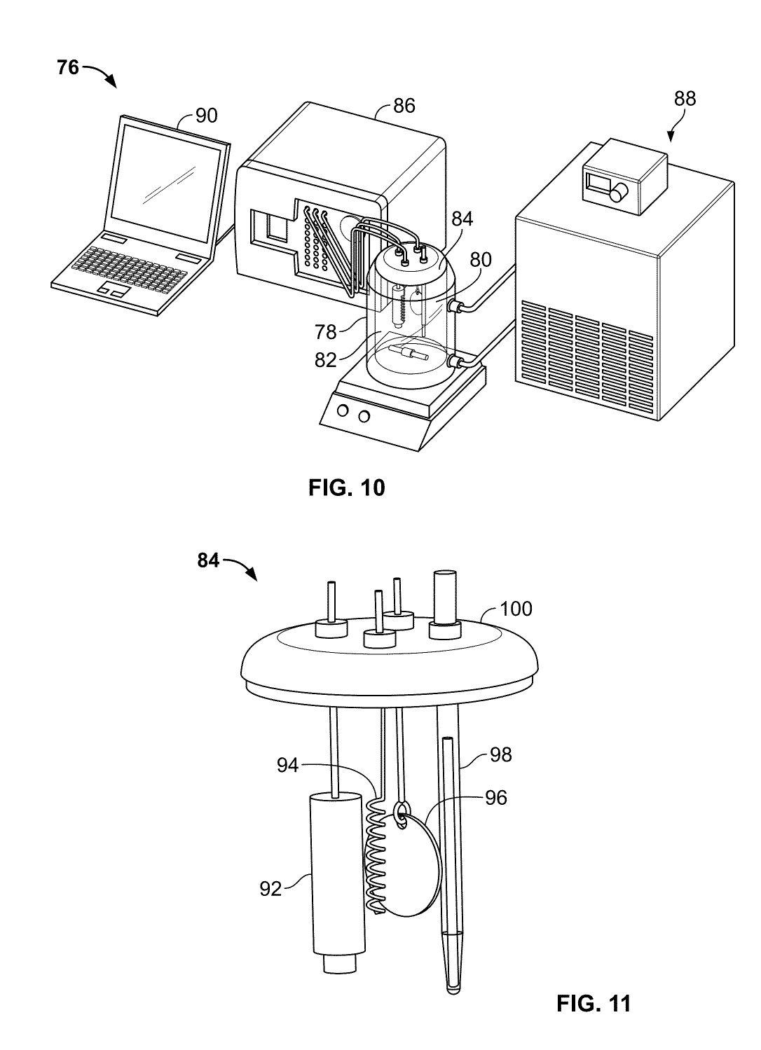

FIG. 10 is a schematic diagram of a corrosion measurement system 76 used to assess the anti-corrosive properties of the exemplary superhydrophobic surfaces discussed above. The corrosion measurement system 76 includes the following components: a test chamber 78 having an electrochemical cell 80, an electrolyte 82 in the cell 80, and a three-electrode system 84 (described in further detail with respect to FIG. 11); an electrochemical analyzer 86; a cooling system 88 for the electrolyte 82; and a computer 90 for receiving and analyzing data from the corrosion measurement tests.

FIG. 11 is a schematic illustration of the three-electrode system 84 of FIG. 10. The three-electrode system 84 includes: a silver/silver chloride (Ag/AgCl) reference electrode 92; a non-reactive platinum (Pt) counter electrode 94; and a specimen of aluminum, with or without an alumina or superhydrophobic surface, as a working electrode 96. A thermometer 98 is also provided. The electrodes 92, 94, 96, and the thermometer 98 penetrate a cover 100 for the test chamber 78, and are secured to the cover 100.

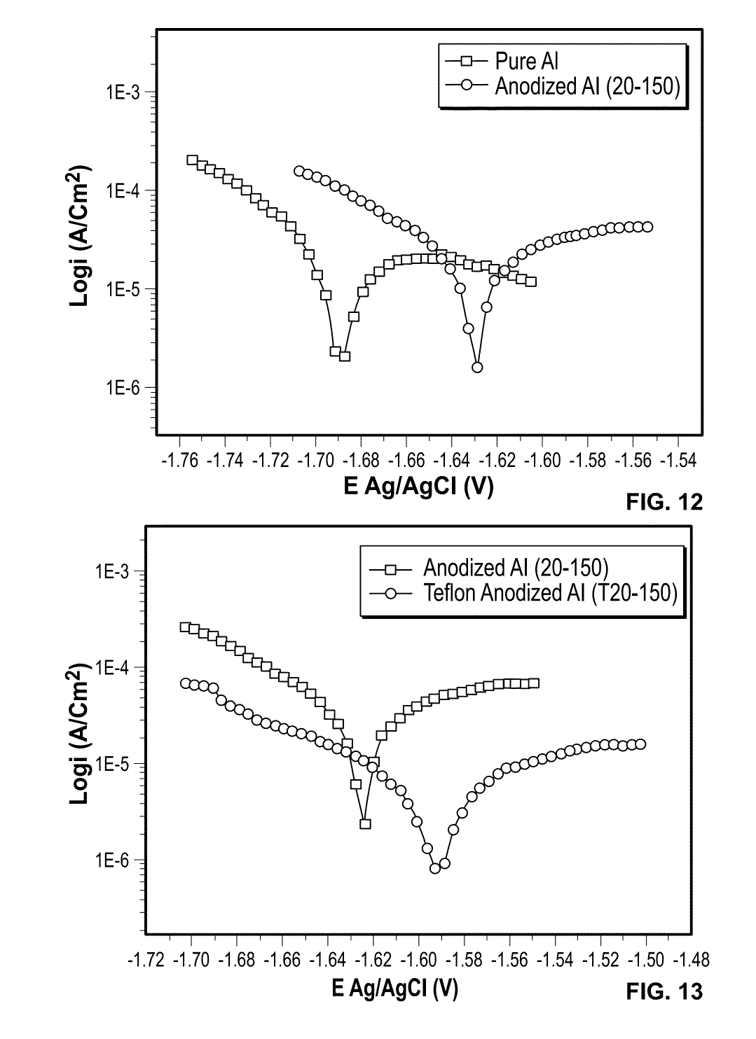

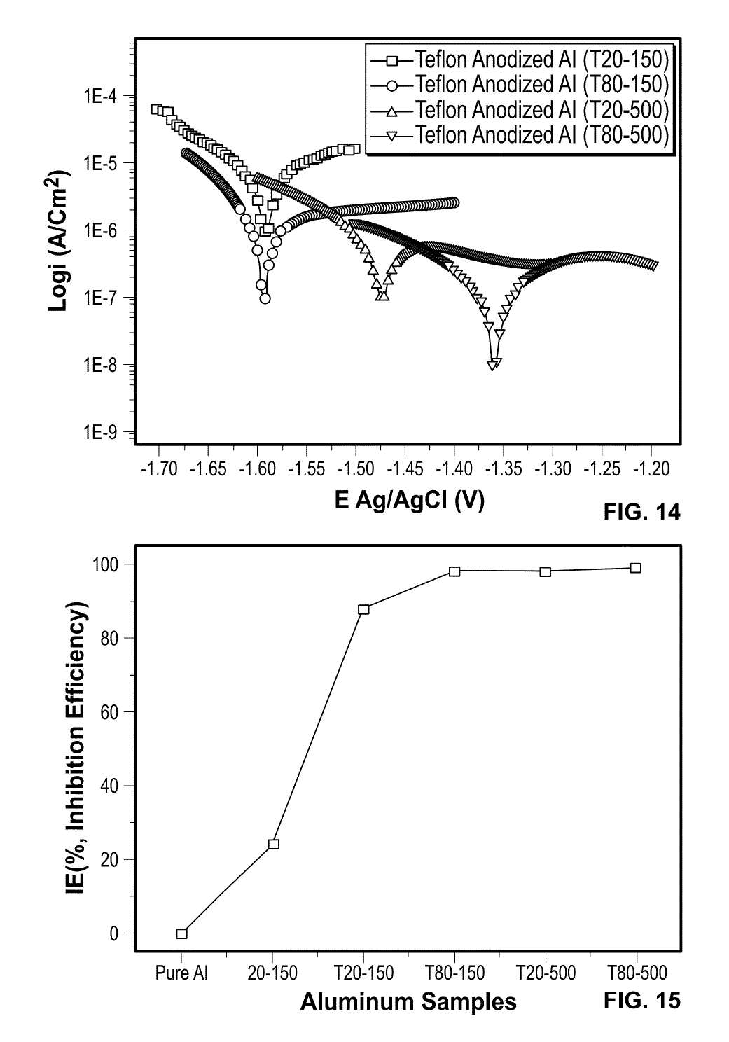

FIG. 12 is a plot of potentiodynamic polarization values for pure aluminum and for exemplary nanoporous alumina surfaces (Specimen 20-150). FIG. 13 is a plot of potentiodynamic polarization values for exemplary nanoporous alumina surfaces (Specimen 20-150) and exemplary Teflon® coated nanoporous alumina surfaces (Specimen T20-150). FIG. 14 is a plot of potentiodynamic polarization values for four exemplary Teflon® coated nanoporous alumina surfaces (Specimens T20-150, T80-150, T20-500, and T80-500). FIG. 15 is a plot of corrosion inhibition efficiencies for pure aluminum (Specimen Pure Al), exemplary nanoporous alumina surfaces (Specimen 20-150), and four exemplary Teflon® coated nanoporous alumina surfaces (Specimens T20-150, T80-150, T20-500, and T80-500). Calculated corrosivity values for the specimens tested are summarized in Table 2, below.

TABLE 2
Corrosion potential (E_{corr}), corrosion current density
(I_{corr}), and inhibition efficiency (IE) of the surface
samples in 3.5% sodium chloride (NaCl) solution.

| | E_{corr} | I_{corr} | IE |
|---|---|---|---|
| Specimens | (V) | (A/cm²) | (%) |
| Bare Aluminum | −1.6785 | 8.5 × 10⁻⁶ | 0 |
| Hydrophilic Porous Aluminum (20-150) | −1.6275 | 6.5 × 10⁻⁶ | 24 |
| Hydrophobic Porous Aluminum (T20-150) | −1.5923 | 9.7 × 10⁻⁷ | 88 |
| Hydrophobic Porous Aluminum (T80-150) | −1.5922 | 9.7 × 10⁻⁸ | 98 |
| Hydrophobic Porous Aluminum (T20-500) | −1.4745 | 1 × 10⁻⁷ | 98 |
| Hydrophobic Porous Aluminum (T80-500) | −1.3607 | 9.8 × 10⁻⁹ | 99 |

Prior to the measurement of potentiodynamic polarization, the specimens were immersed in the electrolyte 82 to ensure that the electrochemical cell 80 would operate at steady state. The working cell was a standard three-electrode cell having platinum as a counter electrode, Ag/AgCl as a reference electrode, and superhydrophobic aluminum as a work electrode (see discussions of FIGS. 10 and 11). The area of the working electrode (surface sample) was 1 cm². The potentiodynamic polarization experiments were performed at ambient temperature (25° C.) in artificial seawater (3.5% NaCl) with the scan from −2 to 0.5 V at a scan rate of 2 mV/s.

The corrosion potential (E_{corr}) and corrosion current (I_{corr}) presented in Table 2 were derived from the potentiodynamic polarization curves (FIGS. 12-14). The inhibition efficiency (IE) (see FIG. 15) is defined as:

$$IE = \frac{{I}_{corr , bare} - {I}_{corr , coated}}{{I}_{corr , bare}} \times 100 \%$$

where I_{corr,bare} and I_{corr,coated} are the corrosion current density for an uncoated surface and an hydrophobic coated alumina surface, respectively.

The corrosion potential (E_{corr}) of the superhydrophobic aluminum surface is has a greater positive value than those of the pure aluminum surface (Specimen Pure Al) and the hydrophilic aluminum surface (Specimen 20-150). The shift in E_{corr} in the positive direction indicates improvement in the corrosion protective properties of the superhydrophobic layer formed on the aluminum surface. It should also be noted that the corrosion current density is reduced after the sample acquires a superhydrophobic surface. Such low current densities indicate an excellent corrosion resistance for the superhydrophobic aluminum surface. The I_{corr} of the T80-500 surface decreases by more than three orders of magnitude compared with that of the pure aluminum surface. This result also indicates that the superhydrophobic surface has better corrosion resistance than the pure aluminum surface. Although the E_{corr} of the T80-150 surface is not smaller than that of the T20-150 surface, the I_{corr} of the T80-150 surface decreases by more than one order of magnitude compared with that of the T20-150 surface. This result indicates that the T80-150 surface, with its larger pore size (resulting in a greater air volume in the superhydrophobic surface) has better corrosion resistance in the 3.5% NaCl solution than does the T20-150 surface. The I_{corr} of the T80-500 surface is the lowest among the specimens tested. These results reveal that entrapping greater amounts of air in the superhydrophic surface provides greater corrosion resistance.

It will be understood that the embodiment of the present invention described herein is merely exemplary and that a person skilled in the art may make many variations and modifications without departing from the spirit and scope of the invention. All such variations and modifications are intended to be included within the scope of the invention as described in the appended claims.

We claim:

1. An artifact, comprising:
an aluminum substrate; and
a superhydrophobic surface structure on said aluminum substrate, said superhydrophobic surface structure including an alumina layer having a nanometer-scale thickness, said alumina layer having a plurality of pores extending through said thickness of said alumina layer, said pores having respective nanometer-scale diameters, and further including a Teflon coating on said alumina layer, whereby air is trapped in said pores so as to substantially exclude water from entering said pores.
